(19) United States
(12) Patent Application Publication
(10) Pub. No.: US 2002/0074311 A1
(43) Pub. Date: Jun. 20, 2002

(54) Methods of endpoint detection for wafer planarization

(76) Inventor: Eric F. Funkenbusch, Hudson, WI (US)

Correspondence Address: MERCHANT & GOULD PC, P.O. BOX 2903, MINNEAPOLIS, MN, 55402-0903, US

(21) Appl. No.: 09/727,935

(22) Filed: Dec. 1, 2000

(51) Int. Cl. B44C 1/22

(52) U.S. Cl. 216/28; 216/85; 216/89

(57) ABSTRACT

A method for monitoring the endpoint for a silicon wafer or other semiconductor device CMP process. A fixed abrasive article, such as a three dimensional abrasive article, is used to planarize the wafer in the presence of a working fluid. A component in the effluent from the CMP process is monitored to predict the CMP endpoint. In some embodiments, the component monitored is a reaction production between a component from the silicon wafer and a reactant.

### FIELD OF THE DISCLOSURE

The present invention relates to methods of detecting the endpoint or other progress of silicon wafer processing, such as planarization. More particular, the invention is to methods that utilize a slurry-free planarization process to detect the endpoint or other progress by analysis of the processing effluent or a component thereof.

### BACKGROUND

In the course of integrated circuit manufacture, a semiconductor wafer typically undergoes numerous processing steps, including deposition, patterning, and etching steps. Additional details on how semiconductor wafers are manufactured can be found in the article “Abrasive Machining of Silicon” by Tonshoff, H. K.; Scheiden, W. V.; Inasaki, I.; Koning. W.; Spur, G. published in the Annals of the International Institution for Production Engineering Research Volume 39/2/1990, pages 621 to 635. At each step in the process, it is often desirable to achieve a pre-determined level of surface “planarity,” “uniformity,” and/or “ roughness.” It is also desirable to minimize surface defects such as pits and scratches. Such surface irregularities may affect the performance of the final semiconductor device and/or create problems during subsequent processing steps.

One accepted method of reducing surface irregularities is to treat the wafer surface with slurry containing a plurality of loose abrasive particles dispersed in a liquid and a polishing pad; this is commonly referred to as “planarizing” or “planarization”. The planarization process is typically a chemical-mechanical polishing (CMP) process. One problem with CMP slurries, however, is that the process must be carefully monitored in order to achieve the desired degree of planarization. It is important that the planarization process be stopped when the correct degree of removal has been achieved; that is, when the proper endpoint has been reached. Removing too much of a film results in loss of wafer yield, while not removing sufficient amounts may require continued planarization or even redepositing of the circuitry.

Various methods have been used to attempt to detect the endpoint at which the polishing should be stopped. These methods include: simple timing, friction, optical results, acoustical results, and conductive characteristics. There have been references related to endpoint detection by chemical analysis; see for example, U.S. Pat. Nos. 6,021,679 and 6,066,564, and PCT Published application WO 99/56972. These references teach detecting the endpoint by monitoring a chemical reaction product caused by the reaction of a component from the abrasive slurry and the wafer.

Improvements are desired in real-time endpoint detection methods and processes for determining when the desired level of planarization of the wafers has been obtained.

### SUMMARY

The present disclosure is directed to methods for achieving more consistent and reliable end point detection for chemical-mechanical-polishing (CMP) operations. Specifically, the disclosure is directed to using a fixed abrasive article during the planarization process and monitoring the effluent from the planarization process to determine the progress of the process. Generally, the level of at least one component in the effluent or of a reaction with a component of the effluent is monitored. In preferred embodiments, this monitoring can be done in situ, so that immediate processing information is obtained.

In accordance with the process and methods of the present disclosure, the silicon wafer or other semiconductor device is subjected to planarization, also known as CMP, by a fixed abrasive article that comprises an abrasive coating affixed to a backing. The abrasive coating may be a textured abrasive coating, meaning that is has a three-dimensional texture, or it can be a lapping film. In some embodiments, the three-dimensional features are shaped composites of abrasive particles and binder. The shaped composites are preferably precisely shaped composites, which have been made by curing a slurry of abrasive particles and binder precursor in a mold to form a composite having the inverse shape of the mold. In some embodiments, the three-dimensional features may not be bound on a backing, but are nevertheless affixed together. In some embodiments, the abrasive coating and the working fluid may both be free of mineral abrasive particles; in such embodiments, the working fluid together with the texture of the three-dimensional coating provide sufficient planarization of the wafer surface.

During the planarization process, the fixed abrasive article is brought into contact with the conductive or dielectric layers present on the surface of the silicon wafer in the presence of a working fluid, such as water or any aqueous or non-aqueous fluid. The material removed from the wafer surface, and any debris or abrasive particles released from the abrasive article, are removed from the wafer/abrasive article interface by the working fluid. This mixture of debris and working fluid is commonly known as the effluent. The amount of debris or contaminants such as abrasive particles, dislodged pieces of binder, silica, or metals or metal compounds such as copper, aluminum, tungsten, titanium, titanium nitride present as intermediate layers on the wafer, are present in relatively low amounts in the effluent. These low levels of undesirable particulate in the effluent, particularly the low levels of abrasive particles and binder pieces, allow for easier monitoring of the processing endpoint than if an abrasive slurry were used for the planarization process.

The technique used for monitoring the endpoint of the planarization process can be any monitoring or detection technique that evaluates at least one property of the effluent. Such techniques include endpoint detection by chemical reaction, electrochemical potential, photoionization, light scattering and light absorption, chemiluminescence, and any combinations or variations thereof. In some embodiments, the technique used monitors a level of a component in the effluent. In other embodiments, the technique monitors a reaction product of a component of the effluent.

Specifically, the present disclosure is directed to a method for detecting the endpoint for removal of a target film overlying a second film, the method comprising removing the target film by chemical-mechanical polishing with a fixed abrasive article in the presence of a working fluid; and monitoring at least one quality of an effluent from the chemical-mechanical polishing until a desired level of the at least one quality is detected. The quality of the effluent is generally the level of a component in the effluent, the component being from the target film, the second film, or a third film. In some instances, this includes reacting a reagent with a component in the effluent to form a reaction product; and then monitoring the reaction product until a desired level of the reaction product is detected. In other instances, the residual reactant of a reaction is monitored.

### DETAILED DESCRIPTION

In silicon wafer planarization, as in many other processes where a thin film is removed from the surface of a substrate, the detection of the process endpoint is critical for achieving optimum processing. Too much processing can remove too much of the target film and can damage the underlying substrate or layer, whereas too little processing does not remove a sufficient amount of the target film. Thus, it is desired to accurately monitor the desired endpoint of the process, and preferably in real time or with a very short delay time.

Numerous techniques for detecting or otherwise monitoring the endpoint of film removal, such as removal of film layers of semiconductor devices being fabricated, are known. Typically, these techniques involve qualitatively monitoring the effluent or any other environment present at the silicon wafer interface. The effluent is a byproduct of the planarization process and generally contains low levels of debris or other contaminants such as abrasive particles, dislodged pieces of binder, and silica from the wafer being planarized. Various aspects of the effluent can be monitored, such as the opacity of the effluent, its ability to react with other chemicals or reagents such as potassium, its ability to reduce compositions, its ability to generate nitrogen gas, the light scattering characteristics of the effluent, and the like. Other endpoint detection techniques operate by chemical reaction, electrochemical potential, photoionization, light scattering and light absorption, chemiluminescence, or any combinations or variations thereof.

Two particularly preferred techniques for monitoring the endpoint are by monitoring the amount of nitrogen generation at the abrasive article/wafer interface, and by monitoring the levels of copper present in the effluent or the abrasive article/wafer interface environment. Some of these techniques are described, for example, in U.S. Pat. No. 6,066,564“Indirect Endpoint Detection by Chemical Reaction” and PCT Publication WO 99/56972 “Indirect Endpoint Detection by Chemical Reaction and Chemiluminescence”. At least one of this issued U.S. patent and this published PCT application makes reference to other pending U.S. patent applications that also describe various endpoint monitoring techniques: U.S. patent application having Ser. No. 09/073601 “Endpoint Detection by Chemical Reaction and Light Scattering”; U.S. patent application having Ser. No. 09/073602 “Endpoint Detection by Chemical Reaction”; U.S. patent application having Ser. No. 09/073607 “Endpoint Detection by Chemical Reaction and Reagent”; U.S. patent application having Ser. No. 09/073603 “Reduction of a Gaseous Product in Solution”; and U.S. patent application having Ser. No. 09/073606 “Endpoint Detection by Chemical Reaction and Photoionization”. Although the specific disclosures of these pending applications are not known to the Applicant of the present invention, it is believed that by using a fixed abrasive article, in accordance with the present invention, the endpoint monitoring results from the various methods disclosed in these applications would be improved. These and any of these endpoint detection methods that are intended to be used for detection of slurry planarization endpoints are improved by the present invention. Further, any known endpoint detection method that monitors or evaluates a property of the effluent or the wafer interface can be used with the present invention.

The majority of these endpoint detection techniques monitor the amount of film material, such as silica or metal, that is removed by the abrasive slurry and washed away with the effluent. Typically, the removed film material is dissolved in the effluent or is present as very small particles, typically on the order of several nanometers. In order to obtain adequate and sufficiently accurate measurement of the film material levels in the effluent, it is usually necessary to filter or otherwise separate the abrasive slurry components from the effluent being tested. These abrasive slurry components include the abrasive particles, matrix materials or binder, and any other fillers or particles that may be present in the abrasive slurry. These abrasive slurry components are generally significantly larger in size than any particulate film material, thus allowing for filtration. However, the surface of the contaminant particles or the filtration equipment may adsorb or absorb a portion of the dissolved film material resulting in unwanted reduced signal and inconsistencies. Further, filtering or otherwise treating the effluent in order to obtain acceptable readings can be difficult, expensive, and time consuming.

By using a fixed abrasive article to planarize or otherwise process the wafer eliminates the disadvantages of using the abrasive slurry and improves the endpoint detection process. The fixed abrasive article usable in the present invention can be any abrasive article that includes an abrasive coating affixed to a backing or forming a continuous sheet. In general, abrasive particles are dispersed in a binder to form an abrasive coating bonded to a backing. In one embodiment, the abrasive articles used in the inventive methods described herein are “three-dimensional” abrasive articles, meaning there are numerous abrasive particles throughout at least a portion of the thickness of the abrasive article. The three-dimensional nature provides a long-lasting abrasive article, because there are numerous abrasive particles available to accomplish the mechanical polishing aspect of the planarization process.

Even if not a three-dimensional abrasive article, the abrasive article often has a “texture” associated with it; that is, it is a “textured” abrasive article. A textured abrasive article or abrasive coating has an irregular or uneven surface topography, generally having troughs or recesses distributed throughout the coating. The troughs or recesses may be positioned in an ordered manner or may be randomly positioned. The recesses act as channels to help distribute the liquid medium over the abrasive article and the interface with the wafer surface. The recesses also act as channels to help remove any worn abrasive particles and other debris from the wafer surface.

Examples of abrasive articles that can be used in the present invention include abrasive articles such as disclosed in U.S. Pat. Nos. 5,152,917 (Pieper et al.), 5,958,794 (Bruxvoort et al.), and PCT published application WO 98/49723 (Kaisaki et al.), each of these being incorporated herein by reference in its entirety. For details regarding fixed abrasive articles for wafer polishing, see for example, U.S. Pat. No. 5,958,794 (Bruxvoort et al.), which describes useful abrasive article features such as backing materials, abrasive particle types and sizes, binder materials, and the like.

The abrasive article used in wafer planarization is generally erodible; that is, with use, it has the ability to wear away in a controlled manner. Erodibility is desired because it results in expelled abrasive particles being expunged from the abrasive article to expose new abrasive particles. Expunged abrasive particles, and also pieces of binder, are removed from the working interface by the effluent. The degree of erodibility is a function of the surface texture, the abrasive coating composition, the planarization conditions and the composition of the semiconductor wafer. Limited erodibility, meaning some erodibility or slow erodibility, is desired in the abrasive article used in the present invention. Significant levels of erosion are not desired, because the material lost from the abrasive article ends up in the effluent. Too much material in the effluent can hinder the endpoint detection techniques.

During the planarization process, the abrasive article is brought into contact with the wafer in the presence of a working fluid, such as water or any aqueous or non-aqueous solution. The abrasive article is moved in relation to the wafer surface, which is planarized by either chemical or mechanical action or a combination thereof (known as CMP). The material removed from the wafer, and any debris or abrasive particles removed from the abrasive article, are removed from the wafer/abrasive article interface by the working fluid. This effluent is then monitored or sampled by any of the previously discussed endpoint monitoring techniques.

By using a fixed abrasive article for the planarization process, the amount of abrasive particles, binder pieces, and other debris that generally hinders the monitoring process, is relatively low when compared to that present when an abrasive slurry is used for the planarization process. The low levels of undesirable particulate in the effluent when using a fixed abrasive article allow for easy monitoring of the processing endpoint by reducing the amount of material that may interfere with the monitoring technique being utilized. For example, if the technique for monitoring the endpoint is based on the opacity of the effluent or its light scattering qualities, minimal particulates and other contaminants provide a more accurate measurement or reading. Using a fixed abrasive article provides significantly less particulate that when using an abrasive slurry. For techniques that monitor the reaction rate or level of a component of the effluent with an added reactant, having minimal non-reactive materials present improves the reaction results, both because the contaminants or non-reactive materials may hinder the reaction and because the surface of the contaminants may adsorb or absorb a portion of one of the reactants or the reaction products. Additionally, no filtration system is needed to filter out the high amounts of particulate associated with a slurry, so minimal or no reactive or reaction materials are adsorbed, absorbed, or otherwise lost on the filtration system.

Another constraint of slurry based CMP processes is dependent on the requirement of maintaining colloidal stability of the polishing slurry. Because the time period needed for shipping and distribution of the abrasive slurry from the manufacturer to the polishing machines in the planarization facilities is typically days or even a week, it is desirable to have the polishing slurries be sufficiently stable so that minimal abrasive particle settling occurs, preferably over many days. Preparation of the slurry immediately prior to polishing is possible but generally not desirable from productivity or consistency standpoints. In addition, many semiconductor fabrication facilities are not equipped to handle chemical mixing operations. As a result of these considerations, most CMP polishing slurries contain additives such as dispersants, surfactants, viscosity modifiers, biocides, buffers, and the like, which are present to improve the stability of the slurry and to reduce any tendency of settling, flocculation or agglomeration of the slurry particles.

The pH of the slurry can also play an important role in its stability; this usually requires that the pH be maintained with in specified limits. pH levels outside of the limits may result in slurry instability. The presence of additives and the restriction to limited pH ranges to maintain stability of the slurry places severe restrictions on the types of end point monitoring techniques that can be employed. In particular, end point processes that rely on chemical reactions may have interference from the additives or the chemical reactions may not proceed sufficiently or rapidly enough for monitoring purposes. Using a fixed abrasive article removes the above constraints that are imposed to maintain colloidal stability of the slurry particles.

As stated above, the techniques for detecting the planarization endpoint can include chemical reaction, electrochemical potential, photoionization, light scattering and light absorption, chemiluminescence, and any combinations or variations thereof. For any of these techniques, the increase or decrease of the property can be monitored, as can the rate of increase or decrease. For example, the increase or decrease of at least one effluent component can be monitored; the effluent component monitored can be a component from the target layer being planarized, the layer above the target layer to be planarized, or the layer below the target layer. As another example, the increase or decrease of a level of a reaction product between one of the previously listed components and an added reagent can be monitored. Additionally or alternately, the increase or decrease of the level of a residual reactant used to form a reaction product can be monitored. Whether the endpoint will be a minimum (decreased level) or a maximum (increased level) will depend on the component being monitored, the layer from which the component is released, and the amount of desired planarization of that layer. These various increases or decreases can be monitored, for example, by monitoring the pH, opacity, color changes, and the like.

It is not necessary that the desired detection endpoint be actually obtained. Rather, the endpoint can be estimated by extrapolating the changing component level over time to determine when the level of planarization will be acceptable. In such embodiments, it is the rate of formation or rate of depletion of a component that is monitored.

By using a fixed abrasive article as the abrasive product for planarization or polishing of the target film, the amount and degree of inaccurate or inconsistent endpoint measurements is greatly reduced. A fixed abrasive article provides more accurate endpoint detection readings and reduces the number and magnitude of inaccuracies in the readings, as compared to when a loose abrasive slurry is used to planarize. Further, a fixed abrasive article does not require filtering or otherwise separating the abrasive particles from the processing effluent, which can decrease the level and accuracy of the readings.

Various modifications and alterations of this invention will become apparent to those skilled in the art without departing from the scope and spirit of this invention, and it should be understood that this invention is not to be unduly limited to the illustrative embodiments set forth herein.

What is claimed:

1. A method for detecting the endpoint for removal of a target film overlying a second film, the method comprising:
(a) removing the target film by chemical-mechanical polishing with a fixed abrasive article in the presence of a working fluid in the absence of an abrasive slurry;
(b) forming an effluent comprising at least a portion of the target film and the working fluid; and
(c) monitoring at least one quality of the effluent from the chemical-mechanical polishing until a desired level of the at least one quality is detected.

2. The method according to claim 1, wherein the step of monitoring at least one quality of the effluent comprises:
(a) reacting a reagent with the effluent to form a reaction product; and
(b) monitoring the reaction product until a predetermined level of the reaction product is detected.

3. The method according to claim 1, wherein the step of monitoring at least one quality of the effluent comprises:
(a) monitoring a level of a component of the target film within the effluent.

4. The method according to claim 3, wherein the component of the target film is selected from copper, aluminum, tungsten, titanium and titanium nitride.

5. The method according to claim 3, wherein the step of monitoring of a level of a component is carried out until the component increases to the predetermined level.

6. The method according to claim 3, wherein the step of monitoring of a level of a component is carried out until the component decreases to the predetermined level.

7. The method according to claim 1, wherein the step of monitoring at least one quality of an effluent comprises:
(a) monitoring a level of a component of the second film within the effluent.

8. The method according to claim 7, wherein the step of monitoring a level of the component of the second film is carried out until the level of the component of the second film increases to the desired level.

9. The method according to claim 2, wherein the step of reacting a reagent with the effluent to form a reaction product comprises:
(a) reacting a reagent with a component of the target layer present in the effluent to form the reaction product.

10. The method according to claim 2, wherein the step of reacting a reagent with the effluent to form a reaction product comprises:
(a) reacting a reagent with a component of the second layer present in the effluent to form the reaction product.

11. The method according to claim 1, wherein the step of removing the target film comprises:
(a) removing the target film and at least a portion of the second film.

12. The method according to claim 11, wherein the step of removing the target film and at least a portion of a second film comprises:
(a) removing the target film and the second film.

13. The method according to claim 12, wherein the step of removing the target film and the second film comprises:
(a) removing the target film, the second film and at least a portion of a third film.
